(19) United States
(12) Patent Application Publication
(10) Pub. No.: US 2009/0039758 A1
(43) Pub. Date: Feb. 12, 2009

(54) BONDING AGENTS FOR FLUORESCENT COLORING MATERIALS, PROCEDURE AND METHOD OF USE

(75) Inventors: Jorg Hinrich Fechner, Mainz (DE); Franz Ott, Konnersreuth (DE)

Correspondence Address: BAKER & DANIELS LLP;111 E. WAYNE STREET, SUITE 800, FORT WAYNE, IN, 46802, US

(73) Assignee: SCHOTT AG, Mainz (DE)

(21) Appl. No.: 12/100,584

(22) Filed: Apr. 10, 2008

(30) Foreign Application Priority Data
Jun. 4, 2007 (DE) 10 2007 026 029.8

(51) Int. Cl. H01J 1/62; C03C 3/064; C03C 3/00; C03C 3/089; C03C 3/095; B32B 5/16; H01J 40/00

(52) U.S. Cl. 313/486; 501/11; 501/47; 501/49; 501/53; 501/77; 428/402; 501/78; 501/64; 156/67; 428/34

(57) ABSTRACT

An adhesive agent for fluorescent dyes for adhering a fluorescent layer on a substrate, wherein the adhesive agent contains or consists of a glass composition.

The invention relates to an adhesive agent for fluorescent dyes for adhering of a fluorescent layer on a substrate, a method for its production and for its use.

### STATE OF THE ART

The fluorescent lamps which are available on the market as a rule exhibit a tubular glass envelope or flat arrangement (FFL). This glass envelope or the glass tube or flat arrangement, in which case for example a lower glass plate and an upper glass plate, upon which the fluorescent layer is applied, are present and both glass plates are soldered with solder glass or plastic solder, forms the reaction space of a gas discharge. There are different fluorescent lamp types, such as for example compact tubular fluorescent lamps (CFL), cold cathode fluorescent lamps (CCFL), gas discharge lamps with external electrodes (EEFL) as well as flat FFL (Flat fluorescent lamp). However, essentially two gas discharge lamps have been successful on the market: one high pressure variant and one low pressure variant. The fluorescent lamp is as a rule a mercury vapor discharge lamp or an inert gas discharge. It has become the generally used lamp. These lamps exist in many sizes, shapes and performance characteristics.

The generation of light in gas discharge lamps is based on the ionization of a gas in the discharge vessel. In the process the gas becomes conductive. For this purpose solid, fluid or gaseous introduced substances—often mercury (Hg) and/or helium (He), neon (Ne), argon (Ar) and/or Xenon (Xe), are excited by means of discharge between two electrodes projecting in the bulb for stimulated emission of light, usually in the UV and visible range. The electrodes can also be installed outside of the gas discharge space, for example on the outside of the glass tube or of the glass substrate, and stimulate the discharge through the glass (so-called EEFL).

Fluorescent lamps have a fluorescent layer on the inside of the tube, which for example is made of oxides of Y, Eu, La, Ce and Tb. In order to apply the fluorescent layer on the inside of the glass tube, these oxides are first mixed in a paste. Normally a binding agent is used for viscosity adjustment, such as for example nitrocellulose. Further it is customary to add one or more adhesive agents to the paste in order to ensure sufficient adhesion of the fluorescent dye on the glass.

In the production of a fluorescent layer in a fluorescent lamp in the process in the so-called “baking” process first an existing binding agent, such as nitrocellulose for example, is annealed. Finally the adhesive agent and the fluorescent powder are fused at a higher temperature with the glass surface.

Up to now salts such as for example CBB (calcium barium borate) and/or CPP (calcium pyrophosphate) have been used as adhesive agents. This adhesive agent should provide a number of properties: it must be compatible with the material of the envelope of the fluorescent lamp and simultaneously with the fluorescent dye being used, i.e. it should not react with these materials or negatively influence them. It should make available a sufficient adhesion between the fluorescent lamp and the fluorescent dye. Further the adhesive agent must not bring about any detrimental effects which could impair in the use of the generation of light. Finally the adhesive agent should along with the described inert properties also be cost-effectively producible or should be acquirable by purchase.

The known adhesive agents, however, have the disadvantage that high temperatures are required for the baking process. These high temperatures result in the fact that with increasing temperature the efficiency of the fluorescent dye is reduced and with this the desired properties of the fluorescent dye are lost.

Up to now in addition one assumed that for a sufficiently solid adhesion of the adhesive agent and of the fluorescent dye to a glass substrate, such as a glass tube, a heating up to very high temperatures is necessary.

Correspondingly it is the object of the present invention to avoid the disadvantages of the state of the art and to provide new, improved adhesive agents which along with a high adhesion capacity meet the requirements in adhesive agents in this area and in addition do not result in a loss of the desired properties of the fluorescent dye, in particular not impairing the efficiency of the fluorescent dye. Further no lead-content glass compositions are to be used.

### DESCRIPTION OF THE INVENTION

The above object is solved in accordance with the invention by means of an adhesive agent for fluorescent dyes for the adhesion of a fluorescent layer on a substrate, containing or consisting of a glass composition.

Surprisingly, it was found that in the case of the use of the fluorescent dye adhesive agent in accordance with the invention that it is not necessary to heat up to very high temperatures. In accordance with the invention a heating up significantly below the processing temperature VA of the adhesive agent is already sufficient to achieve a solid adhesion or a solid bond between the fluorescent layer and the substrate.

Preferably the glass comes from the glass families of phosphate glass, borate glass, sulfophosphate glass or borosilicate glass with high boron content and is preferably free from lead. Preferably the glass does not contain any silicates. For the achievement of a higher melt temperature or for the achievement of a better chemical resistance however, the glass can also have SiO₂ added to it in concentrations of preferably up to 30 percent by weight, more preferably up to 20 percent by weight, in particular up to 10 percent by weight, very especially preferably less than 5 percent by weight.

Glass as an amorphous material is especially preferable for this application as an adhesive agent, since the properties in comparison to the known crystalline materials can be adapted especially well to the respective requirements. This applies for example to the coefficient of thermal expansion (CTE), the glass transformation temperature (Tg) as well as the viscosities of the substrate.

The glass compositions in accordance with the invention, preferably as glass powder, are used as adhesive agents, preferably with particle sizes <10 μm, more preferably <5 μm, especially preferably <2 μm and in particular <1 μm. In an especially preferred embodiment the particle size of the adhesive agent is about ⅛ to about 1/12, in particular about 1/10 of the particle size of the fluorescent dye. In an example the particle size of the adhesive agent would then be 0.7 μm in the case of a particle size of the dye of 7 μm (as an example for a typical value of a fluorescent dye particle) in the case of a ratio of the particle sizes of adhesive agent/fluorescent dye of 1/10.

The glass powder as adhesive agent in accordance with the invention preferably has a glass transformation temperature Tg of <500° C., more preferably <450° C. or <400° C., very especially preferably the Tg is <350° C. or <300° C. The glass adhesive agents in accordance with the invention as a rule exhibit a processing temperature VA (in the case of an assumed viscosity of 10⁴ dpas) of preferably <900° C. or <800° C., more preferably <750° C. or 700° C., very especially preferably <650° C. or even <600° C. The processing temperature is a defined glass parameter (temperature at 10⁴ dPas viscosity) and constitutes the temperature at which a processing of an adhesive agent is possible by means of the setting of a suitable (flow) behavior for the development of a sufficient adhesion. The glass transformation temperature Tg of the adhesive agent in accordance with the invention always lies below its processing temperature VA.

In accordance with the invention it is now possible in surprising manner to fall significantly below the processing temperature VA of the adhesive agent which actually must be observed for processing. Thus the predefined processing temperature VA of the adhesive agent can for example be undershot by at least about 50° C., in particular by at least about 100° C. or at least about 150° C., more preferably by at least 200° C., more preferably yet by at least 250° C., even more preferably by at least about 350° C. or even by at least about 400° C. In accordance with an especially preferred embodiment the processing temperature VA can be undershot by at least about 450° C., more preferably by at least about 500° C., more preferably yet by at least about 550° C. or even by at least about 600° C. and in spite of this a processing (sintering/baking/melting) of the adhesive agent in accordance with the invention can be achieved, as a result of which however a sufficient adhesion is present. In order to illustrate this in an example let us assume the processing temperature VA of an adhesion agent/glass composition of the invention would be 650° C., i.e. at a temperature of 650° C. the adhesive agent would be present with a viscosity of 104 dPas, as a result of which the optimum processing temperature would be given. In accordance with the invention this temperature can now be significantly undershot. For example a temperature of 450° C. for sintering or baking or melting of the adhesive agent in accordance with the invention would be fully sufficient to impart sufficient adhesion to the fluorescent layer. Hence in this case example the processing temperature VA would be undershot by 200° C. and nevertheless a sufficient adhesion would be obtained.

In accordance with an especially preferred embodiment hence a sintering or baking temperature, i.e. the temperature actually used for processing (sintering/melting) of the adhesive agent in accordance with the invention of <700° C., more preferably <650° C. or <600° C., very especially preferably <550° C. or <500° C. is already sufficient. In a quite special embodiment the temperature is <450 or <400° C., in particular temperatures <350° C. or 300° C. can also be used. The sintering or baking temperature in this connection constitutes the maximum temperature in the method in accordance with the invention.

Hence significantly lower temperatures can be used, as a result of which the thermal load of the fluorescent dye can be reduced to a minimum quantity and the properties are not impaired.

It shall be understood that a person skilled in the art is, with the help of his knowledge, in a position to select the components from the described preferred glass compositions in order in this way to get a suitable glass composition all of whose components complement each other in total to 100 percent by weight.

The fluorescent dye adhesive agents exhibit preferably a glass composition made up of the following composition ranges or consist thereof:

For sulfophosphate glass:

| Oxide | Percent by Weight |
|---|---|
| P₂O₅ | 15-60 |
| SO₃ | 5-40 |
| B₂O₃ | 0-20 |
| AI₂O₃ | 0-10 |
| SiO₂ | 0-10 |
| Li₂O | 0-25 |
| Na₂O | 0-15 |
| K₂O | 0-20 |
| CaO | 0-25 |
| MgO | 0-15 |
| SrO | 0-15 |
| BaO | 0-15 |
| ZnO | 0-40, |
| Y₂O₃ | 0-30. |

Optionally this glass can exhibit an SiO₂ content of preferably up to 30 percent by weight, more preferably up to 20 percent by weight, in particular up to 10 percent by weight, very especially preferably less than 5 percent by weight.

This sulfophosphate glass can contain alkali, but is preferably free of it. In particular in a preferred embodiment it is free of sodium, in order to avoid a reaction of the mercury with the sodium. This reaction can lead to so-called “blackening”, which leads to a reduction of the luminosity of the lamp.

In a special embodiment the glass contains yttrium (e.g. as Y₂O₃) for suppression of the so-called blackening.

For a phosphate glass:

| Oxide | Percent by Weight |
|---|---|
| P₂O₅ | 36-80 |
| SO₃ | 0-40 |
| B₂O₃ | 0-1 |
| AI₂O₃ | 0-10 |
| SiO₂ | 0-10 |
| Li₂O | 0-25 |
| Na₂O | 0-15 |
| K₂O | 0-20 |
| CaO | 0-20 |
| MgO | 0-20 |
| SrO | 0-15 |
| BaO | 0-15 |
| ZnO | 0-40, |
| Y₂O₃ | 0-30. |

Optionally this glass can exhibit an SiO₂ content of preferably up to 30 percent by weight, more preferably up to 20 percent by weight, in particular up to 10 percent by weight, very especially preferably less than 5 percent by weight.

This phosphate glass can contain alkali, but is preferably free of it. In particular in a preferred embodiment it is free of sodium, in order to avoid a reaction of the mercury with the sodium, i.e. the so-called “blackening”.

In a special embodiment the glass contains yttrium (e.g. as Y₂O₃) for suppression of the so-called blackening.

For a borate glass:

| Oxide | Percent by Weight |
|---|---|
| P₂O₅ | 13-80 |
| SO₃ | 0-20 |
| B₂O₃ | 6-80 |
| AI₂O₃ | 0-20 |
| SiO₂ | 0-10 |
| CaO | 0-25 |
| MgO | 0-15 |
| SrO | 0-15 |
| BaO | 0-15 |
| ZnO | 0-40 |
| Li₂O | 0-25 |
| Na₂O | 0-10 |
| K₂O | 0-30 |
| Y₂O₃ | 0-30 |

Optionally this glass can exhibit an SiO₂ content of preferably up to 30 percent by weight, more preferably up to 20 percent by weight, in particular up to 10 percent by weight, very especially preferably less than 5 percent by weight.

In a special embodiment the glass contains yttrium (e.g. as Y₂O₃) for suppression of the so-called blackening.

Especially preferably in the case of this glass composition the sum of B₂O₃ and P₂O₅ is greater than 60 percent by weight.

This borate glass can contain alkali, but is likewise preferably free of it. In particular in a preferred embodiment it is free of sodium, in order to avoid a reaction of the mercury with the sodium, i.e. the so-called “blackening”.

For a borosilicate glass with high boron content:

| Oxide | Percent by Weight |
|---|---|
| SiO₂ | 55-69 |
| B₂O₃ | 20-35 |
| AI₂O₃ | 0-10 |
| ΣLi₂O + Na₂O + K₂O | 0-25 |
| CaO | 0-25 |
| MgO | 0-15 |
| SrO | 0-15 |
| BaO | 0-15 |
| ZnO | 0-25 |
| Li₂O | 0-25 |
| Na₂O | 0-10 |
| K₂O | 0-20 |
| Y₂O₃ | 0-25 |

In a special embodiment the glass contains yttrium (e.g. as Y₂O₃) for suppression of the so-called blackening.

This borate glass can contain alkali, but is likewise preferably free of it. In particular in a preferred embodiment it is free of sodium, in order to avoid “blackening”.

In accordance with the invention thus a fluorescent layer covering at least the partial surface will be applied to at least one area of a substrate. The fluorescent layer is in accordance with the invention not particularly restricted. The fluorescent layers used are known to the person skilled in the art. Any known fluorescent material can be used. The following are named by way of example:

Phosphorous mixtures for cold cathode fluorescent lamps (CCFL)

| Mixture | Red | Green | Blue |
|---|---|---|---|
| 1 | Y₂O₃: Eu | LaPO₄: Ce, Tb | (SrCaBaMg)₅(PO₄)₃CI: Eu |
| 2 | Y₂O₃: Eu | MgAI₁₁O₁₉: Ce, Tb | BaMg₂AI₁₆O₂₇: Eu |

The fluorescent layer can be constructed either over part of the surface or the entire surface.

The production of the fluorescent layer can take place in any manner known to a person skilled in the art. Thus the application of the fluorescent layer can be carried out for example by a known coating method such as spraying or application of a solution or a paste, containing a fluorescent dye, spin coating, doctor knife coating, roller coating, silk-screening, dipping or by the application of a fluorescent film. In the case of tubular glass usually a slip is drawn into the tube via reduced pressure.

For the production of a fluorescent layer on a substrate according to the method in accordance with the invention preferably first a mixture of the fluorescent dye, which is for example present in powder form, and of the adhesive agent in accordance with the invention, if necessary together with one or more additives, is generated; preferably this is stirred in the form of a slip or of a paste. In accordance with an especially preferred embodiment the adhesive agent is used as glass powder, wherein the particle size of the adhesive agent to the particle size of the fluorescent dye is selected especially preferably in a ratio in the range of about ⅛ to about 1/12, in particular about 1/10. A binding agent can be used for viscosity adjustment. One preferred binding agent is nitrocellulose. Then the paste is applied to the substrate, in particular to a part of a fluorescent lamp and subjected to a heat treatment.

The heat treatment can take place continuously or step by step, in particular in 1 or 2 steps.

The heat treatment is preferably carried out for example in 2 steps: (1) heat treatment by annealing of the binding agent and (2) heat treatment of the mixture obtained in Step (1), wherein the temperature in Step (2) is set higher than in Step (1). In Step (2) then the highest temperature (maximum temperature) is used in the method.

In an especially preferred embodiment the heat treatment can also be carried out in one step, wherein a temperature ramp is set and the temperature is continuously increased until reaching the maximum temperature (highest temperature in the method). In this connection the binding agent is annealed in the lower temperature range and subsequently the adhesive agent is processed in order to achieve the desired adhesion capacity.

With this first an existing binding agent is annealed. Subsequently the paste or the slip, containing adhesive agent and fluorescent dye, is sintered at a higher temperature with the substrate surface.

The heat treatment is preferably carried out at a temperature <900° C., more preferably <800° C., especially preferably <750° C., very especially preferably <700° C., in particular <650° C., especially <600° C. Very especially preferably the temperature of the heat treatment, as already explained, is set significantly below the processing temperature VA of the adhesive agent. In especially preferred treatments temperatures <500° C., more preferably <450° C. or <400° C., very especially preferably 350° C. or 300° C. are set for sintering/melting of the adhesive agent. The named temperatures are set as the final temperature in the described ranges in the case of the step by step temperature increase in particular for the above Step (2) or in the case of continuous temperature increase and constitute the respective maximum temperatures in the selected process variant.

The use of the adhesive agent of the invention comes into consideration wherever a fluorescent layer is applied to a substrate. Preferred substrates are such that contain glass or consist thereof, very especially preferably the substrate is on a part of a fluorescent lamp, in particular the glass tube or the glass envelope of a fluorescent lamp. The fluorescent lamp in this connection is not subject to any restriction; any known form can be used.

Fluorescent lamps are preferably suitable for use in lights, in particular for backlighting of electronic display units such as displays and LCD screens, such as for example in the case of mobile telephones and computer monitors, and are used as a light source in the production of liquid crystal displays (LCD) as well as in the case of rear illuminated displays (non-self-emitters”).

The use of the adhesive agent in accordance with the invention is especially preferable for miniaturized fluorescent lamps for backlighting of flat screens (so-called backlights), in particular of LCD-TFT displays. For this application such lamps exhibit very small dimensions and accordingly the lamp glass has only an extremely low thickness. For example the envelope glass can be tubular, wherein the diameter of the tubular envelope glass is preferably <1.0 cm, especially preferably <0.8 cm, in particularly preferably <0.7 cm, very especially preferably <0.5 cm.

The wall thickness of the tubular envelope glass is preferably <1 mm, in particular <0.7 mm. In an alternative design the envelope glass of the illuminant can be a flat glass with a thickness of <1 cm. Preferable displays as well as screens are so-called flat displays, in particular TV for flat glass, like flat backlight arrangements.

The structure of the fluorescent lamp is in accordance with the invention not particularly restricted, wherein in accordance with the invention preferably miniaturized backlight lamps are used. Such a backlight lamp can for example be produced from a drawn glass tube. The lamp can be divided into a central part, which is preferably to a large extent transparent, and is present in the form of an envelope glass, as well as two ends, which can be provided with corresponding terminals by placement of metal or metal alloy wires. The possibility exists of melting the metal or the metal wires in an annealing step with the envelope glass. The metal or metal alloy wires are electrode ducts and/or electrodes. Preferably these electrode ducts are tungsten or molybdenum metals or Kovar alloys. The thermal linear expansion (CTE) of the envelope glass matches preferably to a great extent with the linear expansion (CTE) of the electrode ducts, so that in the region of the ducts no voltages or only defined and purposefully employed voltages occur.

Especially preferred backlight lamps are EEFLs (external electrode fluorescent lamp). Such EEFLs are lamps without electrode ducts, since in the case of an electrode-less EEFL backlight the coupling takes place with the help of electric fields. This is an electrode-less gas discharge lamp, i.e. there are no ducts, but rather only outer or external electrodes.

In principle however an internal bonding is also possible. In this case an ignition of the plasma can take place via internal electrodes. This type of ignition is an alternative technology. Such systems are designated as CCFL systems (cold cathode fluorescent lamp).

Within the scope of the invention the glass of the fluorescent lamp is likewise not particularly restricted. Especially preferably glass based on borosilicate glass is used for the envelope glass of the fluorescent lamp. Borosilicate glass comprises as its main components SiO₂ as well as B₂O₃ and as further components alkaline oxide and/or alkaline earth oxide, such as for example Li₂O, Na₂O, K₂O, CaO, MgO, SrO and BaO. For particulars reference is made to DE 20 2005 004 487 U1, whose entire disclosure content is to be incorporated in the present description by reference.

Preferably the envelope glass of the fluorescent lamp exhibits for example a transmission <20%, preferably <1 0%, very especially preferably <10% in the range of a wavelength of about 254 nm or 313 nm.

The advantages of the invention are manifold:

With the present invention adhesive agents are provided with which the adhesion of a fluorescent layer to a substrate can be improved. The substrate is arbitrary with regard to material and form. Preferably a substrate is selected which contains glass or consists thereof. In accordance with a preferred embodiment in the case of the substrate it is a matter of an inner surface of the glass tube of a fluorescent lamp.

The adhesive agent in accordance with the invention is as a glass composition completely inert and reacts neither with the material of the substrate nor with the fluorescent dye or with additives that are present if appropriate. Due to the fact that in the case of the production of the fluorescent layer no excessively high temperatures must be used for formation of a bond of the adhesive agent to the foundation, i.e. the substrate material, it is managed to apply the fluorescent dye to the substrate without impairment of its properties. Surprisingly as a rule a heating to a temperature significantly below the processing temperature VA of the adhesive agent suffices to achieve a sufficiently firm adhesion or bond between the fluorescent layer and the substrate.

Moreover the adhesive agent of the invention, for example in the form of a powder, is easy to manage and can be obtained cost-effectively. By means of variation of the glass composition of the adhesive agent an adaptation to the respectively used materials is managed. Glass is especially suitable as amorphous material for this use as an adhesive agent, since the properties can be adapted particularly well to the respective requirements in comparison with the known adhesive agents in the form of crystalline materials. This applies for example to properties such as the coefficient of thermal expansion (CTE), the glass transformation temperature (Tg) as well as the viscosities of the substrates and the fluorescent dyes.

The invention will be described subsequently with the help of exemplary embodiments, without restricting the invention to said exemplary embodiments.

### EXEMPLARY EMBODIMENTS

TABLE 1

| % by | | | | | | | | | | Emb. |
|---|---|---|---|---|---|---|---|---|---|---|
| weight | Emb. 1 | Emb. 2 | Emb. 3 | Emb. 4 | Emb. 5 | Emb. 6 | Emb. 7 | Emb. 8 | Emb. 9 | 10 |
| SiO₂ | | | | | | | | | | |
| P₂O₅ | 67.50 | 67.50 | 67.50 | 67.50 | 67.50 | 67.50 | 66.90 | 33.46 | 66.30 | 37.50 |
| B₂O₃ | | | | | | | | | | 30.00 |
| AI₂O₃ | 5.00 | 5.00 | 5.00 | 5.00 | 5.00 | 5.00 | 6.20 | | 6.20 | 5.00 |
| Li₂O | 5.00 | 1.50 | 1.50 | 1.50 | 1.50 | | | | | |
| Na₂O | 6.00 | | | | | | | | | |
| K₂O | 1.50 | 11.00 | 11.00 | 11.00 | 11.00 | 12.50 | 11.90 | 14.60 | 12.50 | 12.50 |
| BaO | | | | | | | | | | |
| CaO | | 15.00 | | | 7.50 | 15.00 | | 3.30 | 7.50 | 15.00 |
| MgO | | | | | | | | | | |
| So₃ | | | | | | | | 15.08 | | |
| ZnO | 15.00 | | 15.00 | 15.00 | 7.50 | | 15.00 | 33.56 | 7.50 | |
| Total | 100.00 | 100.00 | 100.00 | 100.00 | 100.00 | 100.00 | 100.00 | 100.00 | 100.00 | 100.00 |

TABLE 2

| % by | Emb. | Emb. | Emb. | Emb. | Emb. | Emb. | Emb. | Emb. | Emb. | Emb. |
|---|---|---|---|---|---|---|---|---|---|---|
| weight | 11 | 12 | 13 | 14 | 15 | 16 | 17 | 18 | 19 | 20 |
| SiO₂ | | | | | | | | | | |
| P₂O₅ | 23.07 | 33.40 | 33.40 | 34.46 | 33.50 | 66.90 | 23.00 | 33.50 | 65.90 | 66.30 |
| B₂O₃ | 53.85 | | | | | | 54.00 | | | |
| AI₂O₃ | | | | | | 6.20 | | | 6.20 | 6.20 |
| Li₂O | | | | | | | | | | |
| Na₂O | | | | | | | | | | |
| K₂O | 23.08 | 14.60 | 14.60 | | | | | | | 12.50 |
| BaO | | | | | | | | | | |
| CaO | | 8.00 | 7.00 | 17.90 | 17.90 | 11.90 | | 17.90 | 11.90 | 7.50 |
| MgO | | | | | | | | | | |
| So₃ | | 15.00 | 15.00 | 15.08 | 15.00 | | | 15.00 | | |
| ZnO | | 29.00 | 30.00 | 32.56 | 33.60 | 15.00 | 23.00 | 33.60 | 16.00 | 7.50 |
| Total | 100.00 | 100.00 | 100.00 | 100.00 | 100.00 | 100.00 | 100.00 | 100.00 | 100.00 | 100.00 |

TABLE 3

| % by | Emb. | Emb. | Emb. | Emb. | Emb. | Emb. | Emb. | Emb. | Emb. | Emb. |
|---|---|---|---|---|---|---|---|---|---|---|
| weight | 21 | 22 | 23 | 24 | 25 | 26 | 27 | 28 | 29 | 30 |
| SiO₂ | | | | | | | | 2.00 | 63.50 | |
| P₂O₅ | 14.05 | 13.10 | 32.70 | 39.40 | 17.00 | 17.00 | 66.90 | 52.00 | | 67.90 |
| B₂O₃ | 52.90 | 53.00 | | | 58.00 | 59.00 | | 7.00 | 29.90 | |
| AI₂O₃ | 12.91 | 13.00 | | | | 0.50 | 6.20 | 0.50 | | 6.20 |
| Li₂O | | | 1.60 | | | 1.50 | | | 1.80 | |
| Na₂O | | | 6.60 | | | 5.00 | | | | |
| K₂O | | | 7.40 | | 6.00 | | | | 4.80 | |
| BaO | | | | | | | 11.90 | 14.00 | | |
| CaO | 2.13 | 2.20 | 1.00 | 8.00 | 5.00 | 2.00 | | 24.50 | | 11.90 |
| MgO | 2.55 | 2.40 | | | 14.00 | 15.00 | | | | |
| So₃ | | | 18.50 | 20.04 | | | | | | |
| ZnO | 15.46 | 16.30 | 32.20 | 32.56 | | | 15.00 | | | 14.00 |
| Total | 100.00 | 100.00 | 100.00 | 100.00 | 100.00 | 100.00 | 100.00 | 100.00 | 100.00 | 100.00 |

TABLE 4

| % by | Emb. | Emb. | Emb. | Emb. | Emb. | Emb. | Emb. | Emb. | Emb. | Emb. |
|---|---|---|---|---|---|---|---|---|---|---|
| weight | 31 | 32 | 33 | 34 | 35 | 36 | 37 | 38 | 39 | 40 |
| SiO₂ | 0.70 | 63.20 | | 0.50 | 4.00 | 2.00 | 1.00 | | 1.00 | 1.00 |
| P₂O₅ | 68.30 | | 36.60 | 69.00 | 72.00 | 71.00 | 75.00 | 66.00 | 72.00 | 68.00 |
| B₂O₃ | 7.20 | 30.00 | | 7.00 | | 1.00 | 10.00 | 15.00 | 6.00 | 13.00 |
| AI₂O₃ | 0.40 | 2.00 | | | 6.00 | | | 1.00 | | |
| Li₂O | | | | | | | | | | |
| Na₂O | | 4.80 | 12.60 | | | | | | | |
| K₂O | | | | | | 3.00 | | 6.00 | | |
| BaO | | | | | | 2.00 | | | | |
| CaO | 9.70 | | 3.30 | 10.00 | 3.00 | 7.00 | 3.00 | 5.00 | 6.00 | 6.00 |
| MgO | 13.70 | | | 13.50 | 15.00 | | | 7.00 | 6.00 | |
| So₃ | | | 15.00 | | | | | | | |
| ZnO | | | 32.50 | | | 14.00 | 11.00 | | 9.00 | 12.00 |
| Total | 100.00 | 100.00 | 100.00 | 100.00 | 100.00 | 100.00 | 100.00 | 100.00 | 100.00 | 100.00 |

TABLE 5

| % by weight | Emb. 41 | Emb. 42 | Emb. 43 | Emb. 44 |
|---|---|---|---|---|
| SiO₂ | 0.20 | 4.16 | 2.5 | |
| P₂O₅ | 66.60 | 67.78 | 55 | 56 |
| B₂O₃ | 10.73 | | 8 | 8 |
| AI₂O₃ | | 6.24 | | |
| Li₂O | | 3.12 | | 5 |
| Na₂O | | | | |
| K₂O | | | | |
| BaO | 13.74 | | | |
| CaO | 8.73 | 3.12 | 2 | |
| MgO | | 15.58 | 1.5 | |
| So₃ | | | | |
| ZnO | | | 31 | 31 |
| Total | 100.00 | 100.00 | 100.00 | 100.00 |

1. An adhesive agent for fluorescent dyes for adhering of a fluorescent layer on a substrate, wherein the adhesive agent contains a glass composition or consists thereof.

2. The adhesive agent according to claim 1, characterized in that the glass composition is selected from phosphate glass, borate glass, sulfophosphate glass and borosilicate glass with high boron content.

3. The adhesive agent according to claim 1, characterized in that the glass composition is free of silicates.

4. The adhesive agent according to claim 1, characterized in that the glass composition exhibits up to 30 percent by weight silicates, preferably up to 20 percent by weight silicates, more preferably up to 10 percent by weight, very especially preferably less than 5 percent by weight.

5. The adhesive agent according to claim 1, characterized in that the glass composition is present in the form of a glass powder which exhibits a particle size of <10 μm, preferably <5 μm, very especially preferably <2 μm and in particular <1 μm.

6. The adhesive agent according to claim 1, characterized in that the glass composition exhibits a glass transformation temperature Tg of <500° C., preferably <400° C., especially preferably <350° C., in particular <300° C.

7. The adhesive agent according to claim 1, characterized in that the glass composition exhibits a particle size of about ⅛ to about 1/12, in particular about 1/10 of the particle size of the fluorescent dye.

8. The adhesive agent according to claim 1, characterized in that the glass composition constitutes a sulfophosphate glass and comprises one of the following compositions:

| Oxide | Percent by Weight |
|---|---|
| P₂O₅ | 15-60 |
| SO₃ | 5-40 |
| B₂O₃ | 0-20 |
| AI₂O₃ | 0-10 |
| SiO₂ | 0-10 |
| Li₂O | 0-25 |
| Na₂O | 0-15 |
| K₂O | 0-20 |
| CaO | 0-25 |
| MgO | 0-15 |
| SrO | 0-15 |
| BaO | 0-15 |
| ZnO | 0-40, |
| Y₂O₃ | 0-30. |

9. The adhesive agent according to claim 1, characterized in that the glass composition constitutes a phosphate glass and comprises one of the following compositions:

| Oxide | Percent by Weight |
|---|---|
| P₂O₅ | 36-80 |
| SO₃ | 0-40 |
| B₂O₃ | 0-1 |
| AI₂O₃ | 0-10 |
| SiO₂ | 0-10 |
| Li₂O | 0-25 |
| Na₂O | 0-15 |
| K₂O | 0-20 |
| CaO | 0-20 |
| MgO | 0-20 |
| SrO | 0-15 |
| BaO | 0-15 |
| ZnO | 0-40, |
| Y₂O₃ | 0-30. |

if appropriate with an SiO₂ content of preferably up to 30 percent by weight, more preferably up to 20 percent by weight, in particular up to 10 percent by weight, very especially preferably less than 5 percent by weight.

10. The adhesive agent according claim 1, characterized in that the glass composition constitutes a borate glass and comprises one of the following compositions:

| Oxide | Percent by Weight |
|---|---|
| P₂O₅ | 13-80 |
| SO₃ | 0-20 |
| B₂O₃ | 6-80 |
| AI₂O₃ | 0-20 |
| SiO₂ | 0-10 |
| CaO | 0-25 |
| MgO | 0-15 |
| SrO | 0-15 |
| BaO | 0-15 |
| ZnO | 0-40 |
| Li₂O | 0-25 |
| Na₂O | 0-10 |
| K₂O | 0-30, |
| Y₂O₃ | 0-30 |

if appropriate with an SiO₂ content of preferably up to 30 percent by weight, more preferably up to 20 percent by weight, in particular up to 10 percent by weight, very especially preferably less than 5 percent by weight.

11. The adhesive agent according to claim 10, characterized in that in the glass composition the sum of B₂O₃ and P₂O₅ is greater than 60 percent by weight.

12. The adhesive agent according to claim 1, characterized in that the glass composition constitutes a borosilicate glass with high boron content and comprises one of the following compositions:

| Oxide | Percent by Weight |
|---|---|
| SiO₂ | 55-69 |
| B₂O₃ | 20-35 |
| AI₂O₃ | 0-10 |
| ΣLi₂O + Na₂O + K₂O | 0-25 |
| CaO | 0-25 |
| MgO | 0-15 |
| SrO | 0-15 |
| BaO | 0-15 |
| ZnO | 0-25 |
| Li₂O | 0-25 |
| Na₂O | 0-10 |
| K₂O | 0-20, |
| Y₂O₃ | 0-25. |

13. The adhesive agent according to claim 1, characterized in that the glass composition does not exhibit any alkali content.

14. The adhesive agent according to claim 1, characterized in that the glass composition is free of sodium.

15. The adhesive agent according to claim 1, characterized in that the substrate contains glass or consists thereof.

16. The adhesive agent according to claim 1, characterized in that the substrate is part of a lamp.

17. The adhesive agent according to claim 16, characterized in that the lamp constitutes a fluorescent lamp.

18. The adhesive agent according to claim 17, characterized in that the fluorescent lamp is selected from EEFLs or CCFLs.

19. The adhesive agent according to claim 17, characterized in that the fluorescent lamp exhibits a tubular envelope glass whose diameter is <1.0 cm and/or whose wall thickness is <1 mm.

20. The adhesive agent according to claim 17, characterized in that the envelope glass of the fluorescent lamp comprises a flat glass with a thickness of <1 cm.

21. The adhesive agent according to claim 17, characterized in that the fluorescent lamp constitutes miniaturized fluorescent lamp, in particular a backlight lamp.

22. A method for producing a fluorescent layer on a substrate with the steps:
application of a mixture containing fluorescent dye, adhesive agent in accordance with claim 1 and if appropriate one or more additives, on a substrate and carrying out of a heat treatment of the mixture.

23. The method according to claim 22, characterized in that the mixture is used in the form of a paste or a slip.

24. The method according to claim 22, characterized in that a binding agent is added to the mixture as an additive.

25. The method according to claim 22, characterized in that the heat treatment comprises 2 steps:
(1) heat treatment b by annealing of the binding agent and
(2) heat treatment of the mixture obtained in Step (1), wherein the temperature in Step (2) (sintering or baking temperature) is set higher than in Step (1).

26. The method according to claim 25, characterized in that the temperature in Step (2) (sintering or baking temperature) is the maximum temperature of the method.

27. The method according to claim 22, characterized in that the heat treatment is carried out in 1 step, wherein the temperature is continuously increased until the reaching of a predefined maximum temperature.

28. The method according to claim 22, characterized in that during the heat treatment first the binding agent is annealed and subsequently an adhesion of the fluorescent layer is achieved by melting and/or sintering and/or baking of the adhesive agent.

29. The method according to claim 26, characterized in that the maximum temperature of the method is set in such a way that the processing temperature VA of the adhesive agent is undershot by at least about 50° C., preferably by at least about 100° C., more preferably by at least about 150° C., more preferably yet by at least about 200° C., very especially preferably by at least about 250° C., in particular by at least 300° C.

30. The method according to claim 26, characterized in that the maximum temperature of the method is set in such a way that the processing temperature VA of the adhesive agent is undershot by at least about 350° C., preferably by at least about 400° C., more preferably by at least about 450° C., more preferably yet by at least about 500° C., very especially preferably by at least about 550° C., in particular by at least about 600° C.

31. The method according to claim 22, characterized in that for the heat treatment a sintering or baking temperature (maximum temperature) of <700° C., more preferably <650° C. or <600° C., very especially preferably <550° C. or <500° C. is already sufficient.

32. The method according to claim 22, characterized in that for the heat treatment a sintering or baking temperature (maximum temperature) of <450° C. or <400° C., preferably <350° C., in particular <300° C. is already sufficient.

33. A fluorescent lamp, comprising a fluorescent layer and an adhesive agent in accordance with claim 1 for adhering of the fluorescent layer on the glass of the fluorescent lamp.

34. A substrate, comprising a fluorescent layer which adheres on the substrate by means of an adhesive agent in accordance with claim 1.

35. The substrate according to claim 34, characterized in that the substrate constitutes a glass envelope of a fluorescent lamp.

36. The use of an adhesive agent in accordance with claim 1 for the adhering of a fluorescent layer on a surface of a fluorescent lamp.
